(19) United States
(12) Patent Application Publication
(10) Pub. No.: US 2018/0127286 A1
(43) Pub. Date: May 10, 2018

(54) AERATION CONTROL SYSTEM AND METHOD FOR WASTEWATER

(71) Applicant: INDUSTRIAL TECHNOLOGY RESEARCH INSTITUTE, Hsinchu (TW)

(72) Inventors: Hsin-Yi CHUNG, Shulin City (TW); Hao-Ting CHAO, Taichung City (TW); Chen-Hua CHU, Zhubei City (TW)

(73) Assignee: INDUSTRIAL TECHNOLOGY RESEARCH INSTITUTE, Hsinchu (TW)

(21) Appl. No.: 15/379,384

(22) Filed: Dec. 14, 2016

(30) Foreign Application Priority Data
Nov. 10, 2016 (TW) 105136708

(51) Int. Cl. C02F 1/00; C02F 1/74

(52) U.S. Cl. CPC C02F 1/008; C02F 1/74; C02F 2209/005; C02F 2209/10; C02F 2209/05; C02F 2209/04

(57) ABSTRACT

An aeration control system and method for wastewater are provided. The aeration system, which is connected to an aeration device in an aeration basin, includes a plurality of water quality detectors, at least one pollutant estimate model, and a processing unit. The plurality of water quality detectors are configured to acquire a plurality of water quality data. The plurality of water quality data includes a pre-aeration water quality data and a post-aeration water quality data. The pollutant estimate model is configured to generate a pollutant data according to the pre-aeration water quality data. The processing unit is configured to generate an aeration quantity according to the pollutant data, the post-aeration water quality, and an effluent water quality setting, and transmitting the aeration quantity to the aeration device.

### CROSS-REFERENCE TO RELATED APPLICATIONS

This non-provisional application claims priority under 35 U.S.C. § 119(a) on Patent Application No(s). 105136708 filed in Taiwan, R.O.C. on Nov. 10, 2016, the entire contents of which are hereby incorporated by reference.

### BACKGROUND

In a wastewater treatment process shown in FIG. 1, a pumping station pumps the influent water to undergo a primary treatment, a secondary treatment, a tertiary treatment, and effluent in sequence. The primary treatment includes steps of grit removing and flow equalization. The secondary treatment includes steps of aeration and precipitation. The tertiary treatment includes steps of coagulation and sand filtration. However, in the secondary treatment, the electrical power consumption for supplying air to the aeration basin or the electrical power consumed by the aeration device, such as the blower, etc., is normally half of the total electrical power consumption of the entire wastewater treatment process, and the high electrical power consumption is usually caused by over aeration.

The length of the aeration time period or the magnitude of the aeration quantity is determined by the effluent water quality, and the amount of dissolved oxygen (DO) is usually selected as the indicator. However, there is a time delay to reflect the influence of the aeration quantity to the amounts of dissolved oxygen, which is the main cause of the over aeration or the lack of aeration. Therefore, it is necessary to create a real-time control system and method for the aeration device to optimize the aeration quantity.

### SUMMARY

In an embodiment of the present disclosure, an aeration control system for wastewater includes a plurality of water quality detectors, at least one pollutant estimate model, and a processing unit. The plurality of water quality detectors are for acquiring a plurality of water quality data. The plurality of water quality data includes a pre-aeration water quality data and a post-aeration water quality data. The pollutant estimate model is for generating a pollutant data according to the pre-aeration water quality data. The processing unit is for generating an aeration quantity according to the pollutant data, the post-aeration water quality and an effluent water quality setting, and transmitting the aeration quantity to an aeration device.

In another embodiment of the present disclosure, an aeration control method for wastewater includes the following steps. Acquire a plurality of water quality data by a plurality of water quality detector. The plurality of water quality data includes a pre-aeration water quality data and a post-aeration water quality data. Generate a pollutant data by at least one pollutant estimate model according to the pre-aeration water quality data. Generate an aeration quantity by a processing unit according to the pollutant data, the post-aeration water quality, and an effluent water quality setting. Transmit the aeration quantity to an aeration device by the processing unit. Determine an error value between the post-aeration water quality and the effluent water quality setting is smaller or equal to an allowable range. If yes, end all steps. If no, replace or update the pollutant estimate model.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a schematic view of an aeration control system for wastewater in an embodiment of the present disclosure;

FIG. 2 is a schematic view of a control architecture of the aeration control system for wastewater in the embodiment of the present disclosure;

FIG. 3 is a flow chart of a pollutant estimate model training procedure in an aeration control method for wastewater in an embodiment of the present disclosure; and

FIG. 4 is a flow chart of a control procedure in the aeration control method for wastewater in the embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

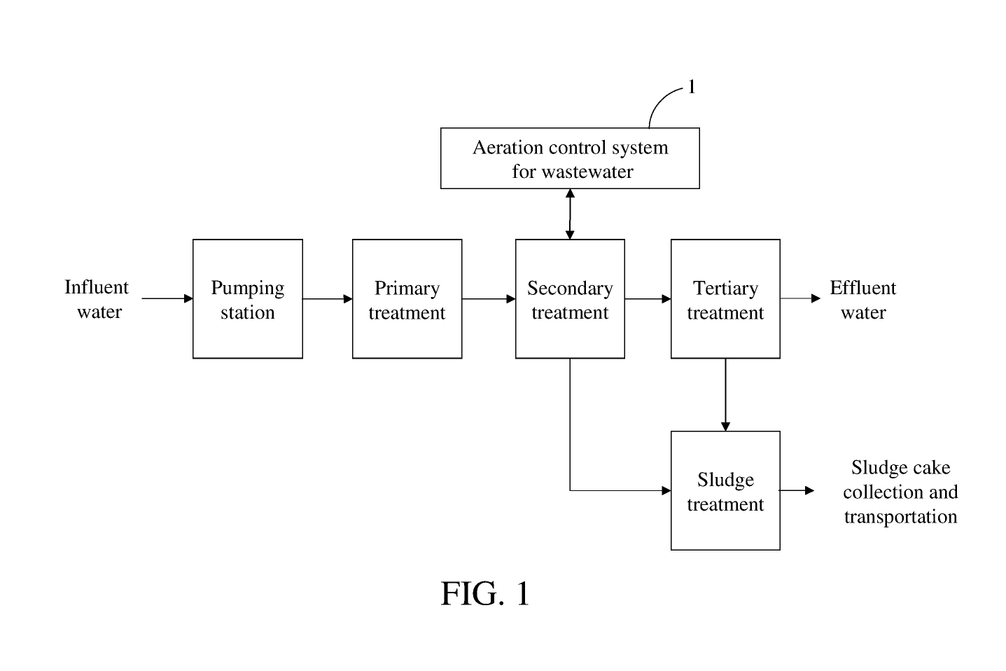

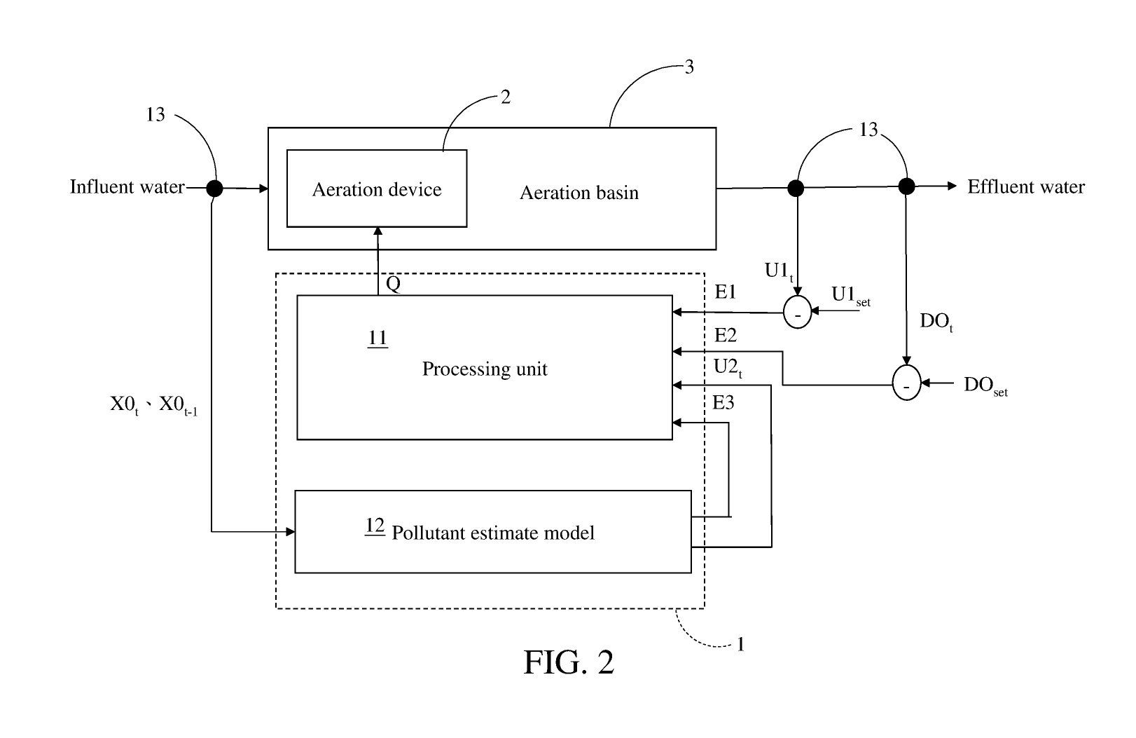

FIG. 1 is a schematic view of an aeration control system for wastewater in an embodiment of the present disclosure. FIG. 2 is a schematic view of a control architecture of the aeration control system for wastewater in the embodiment of the present disclosure. As shown in FIG. 1 and FIG. 2, the aeration control system 1 for wastewater in the embodiment of the present disclosure, for example, is configured to connect an aeration device 2 for wastewater treatment, such as a blower, etc. The aeration device 2 in an aeration basin 3 is configured to provide air to the aeration basin 3 in the secondary treatment so as to stir the wastewater in the pool, which improves the decomposition of the organic pollutant. As shown in FIG. 2, the aeration control system 1 for wastewater in the embodiment of the present disclosure includes a processing unit 11, a plurality of pollutant estimate models 12, and a plurality of water quality detectors 13. One water quality detector 13 is disposed at the influent side, and one water quality detector 13 is disposed at the effluent side of the aeration basin 3. The water quality detector 13 is used for detecting water qualities of the wastewater before and after the aeration by the aeration device 2. The data, which indicate the water quality, are usually related to the type of the detector. The data, for example, are the amount of dissolved oxygen (DO), the oxidation-reduction potential (ORP), the electrical conductivity (EC), the amount of suspended solid (SS), the potentials of hydrogen (pH), or the Temperature (T), etc., but the disclosure is not limited thereto. In other embodiments, two types of the detectors are used for detecting the water qualities; the first type detectors are paired to be respectively disposed at the influent side and the effluent side for detecting, for example, the DO, and the second type detectors are also paired to be respectively disposed at the influent side and the effluent side for detecting, for example, the ORP.

The plurality of pollutant estimate models 12, for example, have been trained before being built in a storage (not shown in the figures) of the aeration control system 1 for wastewater. Each of the plurality of pollutant estimate models 12 includes applicable conditions, adjustment parameters, an allowance of error, weights, and deviants, etc. which are built by a training method according to historical water quality data. In addition, the plurality of pollutant estimate models 12 are adaptively adjustable referring to real-time water quality data. The pollutant estimate model 12, which is confirmed and selected, compares the pre-aeration water quality data transmitted from the plurality of water quality detectors 13, such as one combination of actual influent water qualities at time X0ₜ, and the other combination of actual influent water qualities at time X0ₜ₋₁, wherein the time are different time points. The pollutant estimate model 12 compares the pre-aeration water quality data so as to output a pollutant data which reflects a trend of pollutant loading at the time. The pollutant data is an estimated value matching or close to an actual situation. The pollutant data includes, for example, a trend variation of influent pollutants E3 (mg/L), an influent pollutant value U2ₜ (mg/L), etc. However, as shown in FIG. 2, after comparing an actual effluent water quality with an effluent water quality setting, if the error value is not in the allowance of error, the selected pollutant estimate model 12 has to be updated, replaced, or re-trained and rebuilt. Therefore, the aeration control system 1 for wastewater rebuilds or updates the pollutant estimate model 12 so as to continue to perform the comparison. The above behaviors implemented by the selected pollutant estimate model 12, such as the comparison, the amendment, the output, the judgement, the selection, etc., are performed by the processing unit 11, but the disclosure is not limited thereto.

The processing unit 11 is a processing module, which has a mathematical operation function and a logic judgment function, in the aeration control system 1 for wastewater. Please refer to FIG. 2, the processing unit 11 not only receives pollutant data (E3 [symbol] U2ₜ) output by the pollutant estimate model 12 but also receive post-aeration water quality data (U1ₜ [symbol] DOₜ) detected by the water quality detectors 13. Except for receiving and referring to the pollutant data (E3 [symbol] U2ₜ) and the post-aeration water quality data (U1ₜ [symbol] DOₜ), the processing unit 11 also refers to effluent water quality settings (U1ₛₑₜ [symbol] DOₛₑₜ), specifications of the aeration basin 3 and the aeration device 2 so as to output an aeration quantity Q (cubic meter per minute, CMM or liter per minute, LPM). The effluent water quality settings (U1ₛₑₜ [symbol] DOₛₑₜ) is, for example, an effluent pollutant value U1ₜ (mg/L), an amount of dissolved oxygen DOₜ (mg/L) in the effluent water, an effluent pollutant setting U1ₛₑₜ (mg/L), an amount of dissolved oxygen setting DOₛₑₜ (mg/L) in the effluent water, etc. The specification of the aeration basin 3 or the aeration device 2 is, for example, a volume of the aeration basin, a hydraulic retention time (HRT), a control mode of the blower, etc. In other embodiments, the processing unit 11 only refers to the pollutant data (E3 [symbol] U2ₜ), the post-aeration water quality data (U1ₜ [symbol] DOₜ), and the effluent water quality settings (U1ₛₑₜ [symbol] DOₛₑₜ) to output an aeration quantity Q. The processing unit 11 transmits the aeration quantity Q to the aeration device 2 so as to notify or command the aeration device 2 to perform the aeration, and the water quality after the aeration is estimated to meet a standard effluent water quality.

The processing unit 11 performs the control according to differences between the post-aeration water quality data (U1ₜ, DOₜ) and the effluent water quality setting (U1ₛₑₜ, DOₛₑₜ), which are a pollutant error value E1 and an error value of the amount of dissolved oxygen E2, and the pollutant data (E3, U2ₜ) described above. The control performed by the processing unit 11 is called a feedforward control and a feedback control.

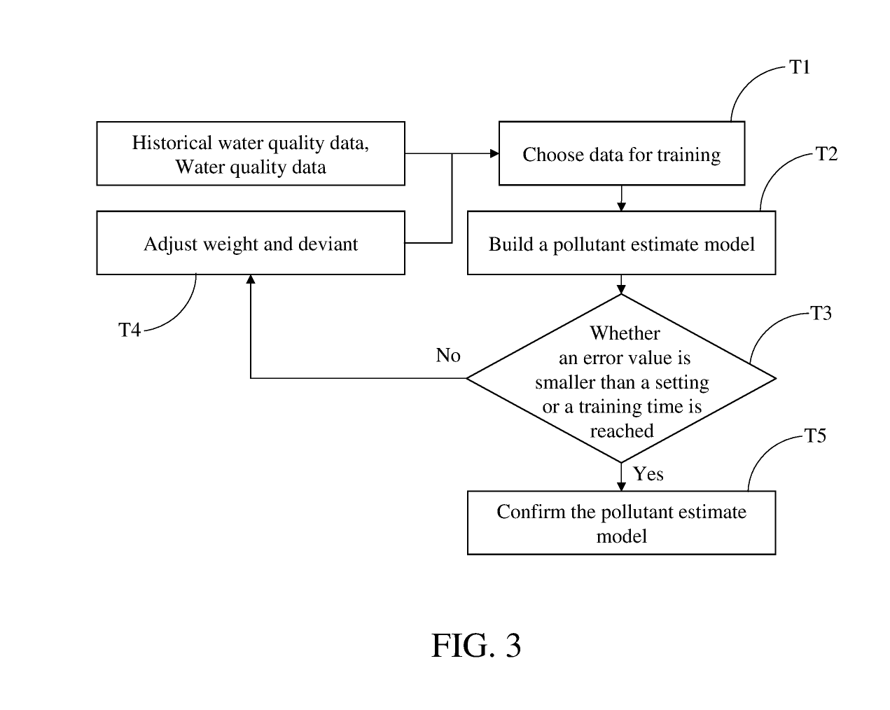

FIG. 3 is a flow chart of a pollutant estimate model training procedure in an aeration control method for wastewater in an embodiment of the present disclosure. FIG. 3 shows a training method of the pollutant estimate model 12 so as to confirm the contents of the pollutant estimate model 12 and build the pollutant estimate model 12 in the aeration control system 1 for wastewater. The training method has the following steps.

In step T1, choose the data for training, wherein the data is selectable from the historical water quality data detected before, or the historical water quality data adjusted referring to the real-time water quality data.

In step T2, after choosing the data for training, next, set the setting corresponding to the parameter in the data for training, the allowance of error, etc. to build a candidate pollutant estimate model.

In step T3, compare the pollutant estimate model with the historical water quality data or the real-time water quality data. If the error value is larger than the setting or a training time is not reached, adjust the weight or the deviant, which is step T4, and go back to step T1. If the error value is equal to or smaller than the setting or the training time is reached, confirm the content of the pollutant estimate model 12 and end the training, which is step T5.

After the plurality of pollutant estimate models 12 having been trained, the plurality of pollutant estimate models 12 are stored in the storage of the aeration control system 1 for wastewater so as to be chose or updated by the processing unit 11. The training for the pollutant estimate models 12 is selectable to be performed by a system having an ability to perform the training method described above except the aeration control system 1 for wastewater, and the plurality of pollutant estimate models 12 are move back to the aeration control system 1 for wastewater after the training is finished.

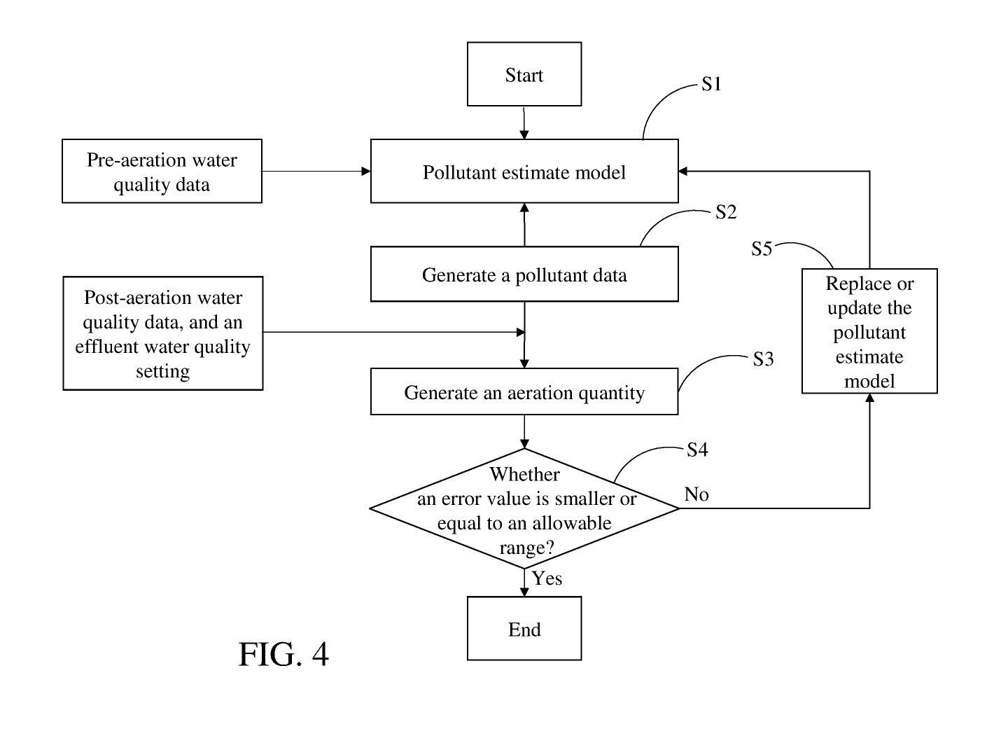

FIG. 4 is a flow chart of a control procedure in the aeration control method for wastewater in the embodiment of the present disclosure. FIG. 4 shows the steps that how the pollutant estimate model 12 performs the pre-aeration water quality comparison so as to generate the pollutant data to the processing unit 11, and the followings are the steps.

In step S1, preliminarily select a pollutant estimate model 12 which the training is completed.

Is step S2, the pollutant estimate model 12 generates a pollutant data according to the pre-aeration water quality data and transmits the pollutant date to the processing unit 11.

In step S3, the processing unit 11 generates an aeration quantity according to the post-aeration water quality, the pollutant data, and an effluent water quality setting, or further according to specifications of an aeration basin 3 and the aeration device 2, and the processing unit 11 transmits the aeration quantity to the aeration device 2 to perform the aeration.

In step S4, determine whether an error value between the post-aeration water quality and the effluent water quality setting is smaller or equal to an allowable range;

if yes, end all steps;

if no, replace or update the pollutant estimate model 12, which is step S5, and go back to step S1.

The aeration control system and method for wastewater in the present disclosure adaptively select the plurality of trained and confirmed pollutant estimate models for performing the feed forward control and the feedback control together according to the pre-aeration water quality and post-aeration water quality so as to avoid the over aeration or the lack of aeration. Therefore, the aeration control system and method for wastewater in the present disclosure optimize the energy consumption of the aeration device when the effluent water quality meets the standard effluent water quality.

What is claimed is:

1. An aeration control system for wastewater, which is connected to an aeration device in an aeration basin, comprising:
a plurality of water quality detectors configured to acquire a plurality of water quality data, and the plurality of water quality data including a pre-aeration water quality data and a post-aeration water quality data;
at least one pollutant estimate model configured to generate a pollutant data according to the pre-aeration water quality data; and
a processing unit configured to generate an aeration quantity according to the pollutant data, the post-aeration water quality and an effluent water quality setting, and transmitting the aeration quantity to the aeration device.

2. The aeration control system according to claim 1, wherein the plurality of water quality data are selected from the group consisting of amounts of dissolved oxygen (DO), oxidation-reduction potentials (ORP), electrical conductivities (EC), amounts of suspended solid (SS), potentials of hydrogen (pH) and combinations thereof.

3. The aeration control system according to claim 1, wherein the at least one pollutant estimate model is build by a training method according to a plurality of historical water quality data and/or the plurality of water quality data.

4. The aeration control system according to claim 1, wherein the aeration quantity is generated by the processing unit according to the pollutant data, the post-aeration water quality, the effluent water quality setting, and specifications of the aeration basin and the aeration device.

5. The aeration control system according to claim 1, wherein the aeration device is a blower.

6. An aeration control method for wastewater, which is applied to control an aeration device in an aeration basin, comprising the steps of:
acquiring a plurality of water quality data by a plurality of water quality detector, and the plurality of water quality data including a pre-aeration water quality data and a post-aeration water quality data;
generating a pollutant data by at least one pollutant estimate model according to the pre-aeration water quality data; and
generating an aeration quantity by a processing unit according to the pollutant data, the post-aeration water quality and an effluent water quality setting, and transmitting the aeration quantity to the aeration device; and
determining whether an error value between the post-aeration water quality and the effluent water quality setting is smaller than or equal to an allowance of error;
if yes, end all steps;
if no, replace or update the pollutant estimate model.

7. The aeration control method according to claim 6, wherein the plurality of water quality data are selected from the group consisting of amounts of dissolved oxygen (DO), oxidation-reduction potentials (ORP), electrical conductivities (EC), amounts of suspended solid (SS), potentials of hydrogen (pH) and combinations thereof.

8. The aeration control method according to claim 6, wherein the at least one pollutant estimate model is build by a training method according to a plurality of historical water quality data and/or the plurality of water quality data.

9. The aeration control method according to claim 8, wherein the training method includes following steps:
building the pollutant estimate model;
comparing the plurality of historical water quality data and/or the plurality of water quality data by the pollutant estimate model; and
determining whether an error value between the plurality of historical water quality data and/or the plurality of water quality data is smaller than or equal to a setting value;
if yes, confirm the pollutant estimate model;
if no, adjust a weight and a deviant, and repeat the step of building the pollutant estimate model.

10. The aeration control method according to claim 6, wherein the aeration quantity is generated by the processing unit according to the pollutant data, the post-aeration water quality, the effluent water quality setting, and specifications of the aeration basin and the aeration device.
